(19) United States
(12) Patent Application Publication
(10) Pub. No.: US 2022/0342517 A1
(43) Pub. Date: Oct. 27, 2022

(54) SELECTING ALL ITEMS OR DISPLAYED ITEMS

(71) Applicant: SAP SE, Walldorf (DE)

(72) Inventors: Georg Christoph, Karlsruhe (DE); Sabina Hitzler, Heidelberg (DE)

(21) Appl. No.: 17/236,913

(22) Filed: Apr. 21, 2021

(51) Int. Cl. G06F 3/0482; G06F 3/0484; G06F 40/177

(52) U.S. Cl. CPC G06F 3/0482; G06F 3/04845; G06F 40/177

(57) ABSTRACT

In some embodiments, there may be provided a method that includes retrieving a first portion of a data table from a data store, wherein the first portion of the data table is a subset of the data table, and wherein the first portion is determined based on a first factor; in response to detecting of a select all operation, presenting a user interface including a first user interface element and a second user interface element, wherein the first user interface element is configured to indicate all of the data table is included in the select all operation, and wherein the second user interface element is configured to indicate the first portion of the data table is included in the select all operation; and detecting, at the computer device, a selection of the first user interface element or the second user element. Related systems and articles of manufacture are also disclosed.

### BACKGROUND

Many organizations may rely on enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. Some enterprise software applications may be hosted by a cloud-computing platform such that the functionalities provided by the enterprise software applications may be accessed remotely by multiple end users at computing devices. For example, an enterprise software application may be available as a cloud-based service including, for example, a software as a service (SaaS) and/or the like.

### SUMMARY

In some embodiments, there may be provided a method that includes retrieving a first portion of a data table from a data store, wherein the first portion of the data table is a subset of the data table, and wherein the first portion is determined based on a first factor; presenting, at a computing device, the first portion of the data table; detecting, at the computing device, a select all operation associated with the data table; in response to the detecting of the select all operation, presenting a user interface including a first user interface element and a second user interface element, wherein the first user interface element is configured to indicate all of the data table is included in the select all operation, and wherein the second user interface element is configured to indicate the first portion of the data table is included in the select all operation; and detecting, at the computer device, a selection of the first user interface element or the second user interface element.

In some variations, one or more of the features disclosed herein including the following features can optionally be included in any feasible combination. In response to detecting the selection of the first user interface element, an operation may be performed on all of the data in the data table. The method may include receiving an indication of the operation, the operation including at least one of a copy, a delete, and a move on all of the data table. In response to detecting the selection of the second user interface element, an operation may be performed on the first portion of the data table. The method may include receiving an indication of the operation, the operation including at least one of a copy, a delete, and a move on the first portion of the data table. The first factor may include a display size of the computing device. The first factor may include a filtering of the data table. The computing device may include the data store. The data table may comprise a database table. The data store may include a database coupled to the computing device via a network. The information regarding the selection of the first user interface element or the second user interface element may be provided to the database.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system, in accordance with some implementations of the current subject matter;

FIGS. 2A-2F depict examples of user interfaces which may be used to select all data, in accordance with some implementations of the current subject matter;

FIGS. 3A-3F depict additional examples of user interfaces which may be used to select all data, in accordance with some implementations of the current subject matter;

FIG. 4 depicts another example of a user interface which may be used to select all data, in accordance with some implementations of the current subject matter;

FIG. 5 illustrates an example of a process, in accordance with some implementations of the current subject matter; and

FIG. 6 is another example of a system, in accordance with some implementations of the current subject matter.

### DETAILED DESCRIPTION

Database tables can be quite large. For example, a user interface at a computing device may access a database table at a database management system. The user interface may access and present at least a portion of the data from this table via a display at the computing device to enable operations, such as displaying data, scrolling through data, copying data, deleting data, adding new data, editing existing data, moving data, and/or other actions on the table data. The underlying data may be stored (in whole or in part) at the database management system. As the user interface accesses data stored in one or more database tables for example, the data is provided (at least in part) to the computing device to enable the operations.

At the user interface, a selection may be performed to “select all” data in the database table. However, this “select all” operation may be referring to all of the data items currently being presented via the display of the computing device or may be referring to all of the data items of the database table. This ambiguity at the user interface may cause unnecessary performance slowdowns. For example, if the “select all” refers to only the 19 data items currently being presented at the user interface, selecting all items in the database table of, for example, 1000 items is not only an unintended action but also deteriorates database performance as the database is needlessly processing 981 data items (which were not intended to be selected by the “select all” of only the 19 data items currently being displayed). In some example embodiments, there is provided a way to address this ambiguity so that the “select all” can be specified to be (1) all of the data of a database table or (2) only the database table data currently being presented on a physical display of the computing device presenting the data.

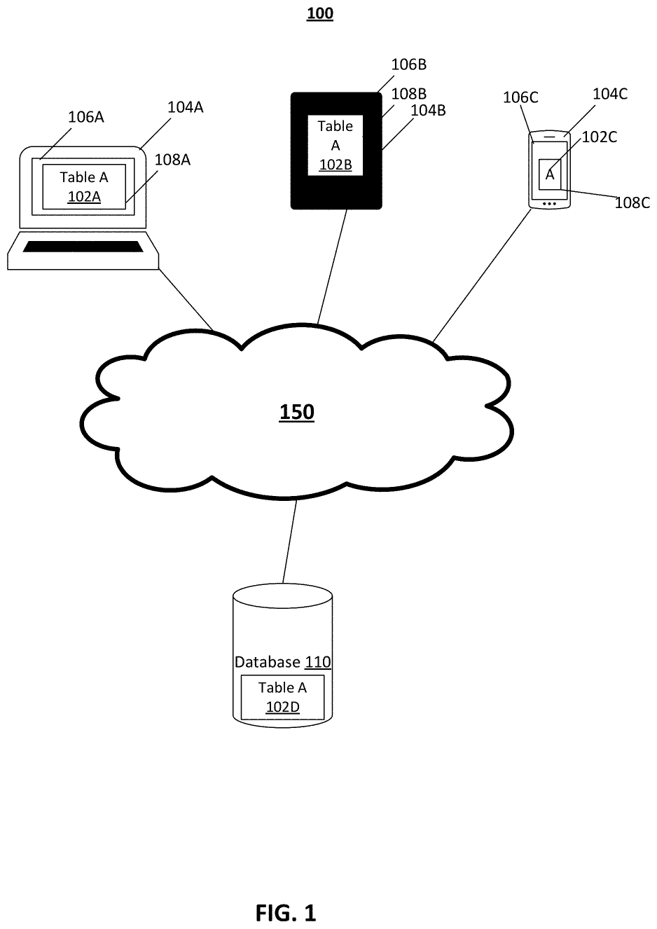

FIG. 1 depicts an example of a system 100, in accordance with some example embodiments. The system 100 may include one or more computing devices 104A-C which may access, via network 150, a database management system 110. In the example of FIG. 1, the computing devices are depicted as a desktop computer 104A, a tablet computer 104B, and a smartphone 104C, but other types and quantities may be implemented as well.

In the example of FIG. 1, the computing device 104A includes a display 106A. This physical display 106A may have a physical size, which in the case of a desktop computer may be specified in terms of a pixel width and pixel height (e.g., 1,920 pixels by 1080 pixels), although other sizes are possible as well. The computing device 104A may also include a user interface 108A, such as a browser, a client application, and/or other applications configured to present, access, and/or the like database table data at the database management system 110. In the example of FIG. 1, the user interface 108A presents, via the display 106A, database table data 102A (labeled Table A) obtained from one or more tables (e.g., Table A 102D) at the database management system 110.

For example, the user interface 108A may send (via network 150) to the database management system 110 a request or a query for at least a portion of the database table data from Table A 102D, so that the computing device 104A/user interface 108A can perform one or more operations (e.g., present, scroll, delete, copy, move, etc.) on that data. In response to the request or the query, the database management system 110 (or more simply “database”) may provide at least a portion of the database table data to the computing device 104A including the user interface 108A to enable at least presentation of that data.

The display sizes may, as noted, vary among the computing devices 104A-C. And, even among similar devices, the display size may vary. For example, a first device and a second device may have the same physical display size, but each device may be configured differently so that the viewable or usable display size area for presenting information differs between the first and second devices. To illustrate further, the first device may be configured to have a resolution of 1080 pixels by 1920 pixels and the second device may be configured to have a resolution of 600 pixels by 800 pixels. As this example illustrates, differences in display size may be due to a variety of factors, such as the physical display size of a screen, the resolution configured at the device, user preference, a size of a user interface being used to view the information (e.g., the size of a user interface view or window may be re-sized on a display screen), and the like. As used herein, the phrase “display size” refers to the size of an area that is being used for the presentation of information, such as database table data.

The database 110 may format the database table data based on (e.g., in response to) the display size being used at the display 106A. For example, the computing device 104A may provide display size information to the database 110, so that the database 110 can format the database table data (e.g., “data”) responsive to the query in a format based on the given display size. To illustrate further, the display size information (e.g., 1,920 pixels by 1080 pixels, size of window, etc.) of computing device 104A may be provided as part of the query sent to the database 110 or at other times as well (e.g., during the registration of the computing device 104A with the database management system, etc.). As used herein, responsive table data refers to table data from a database table that is formatted at least in part based on the display size of the computing device presenting the table data. Although the previous example refers to the database 110 formatting the table data based on the display size, a display controller at the computing device 104A may also format, based on the display size information of computing device 104A, the database table data.

In the example of FIG. 1, the computing device 104B includes a display 106B having a certain physical size, which may be different (or the same) in size when compared to the displays 106A and/or 106C. The computing device 104B may also include a user interface 108B, such as a browser, a client application, and/or other type of application that enables presenting, accessing, and/or the like of database table data at a database management system 110. The user interface 108B may send (via network 150) to the database management system 110 a query or a request for at least a portion of the database table data, which in in this example results in a portion of the database table data 102B (labeled 102B) formatted for the display size of computing device 104B. In some implementations, the entire data table 102D may be sent to the computing device 104B and stored in a local memory. When this is the case, a display controller at the computing device 104B may format the table data based on the display size (e.g., selects how much and/or which portion of data table 102D to present on the display 102B). This operation is also possible in computing devices 104A and 104C.

Moreover, the computing device 104C includes a display 106C having a certain physical size, which may be different in size when compared to the displays 106A and/or 106B. The computing device 104C may also include a user interface 108C, such as a browser, a client application, and/or other types of applications that enable presenting, accessing, and/or the like database table data at a database management system 110. The user interface 1080 may send (via. network 150) to the database management system 110 a query or a request for at least a portion of the database table data, which in in this example results in database table data 102C (labeled 102C) formatted for the display size of computing device 104C.

The use of the display size may enable the tables to be formatted in response to the current and/or available display size at a computing device. The display size may be dynamic in the sense that the display size may vary at a given device from time to time (e.g., the resolution may be varied or configured, a size of a user interface view may be re-sized, etc.). Nonetheless, the display size currently being used at the computing device may allow the tables to be presented in a format that takes into account the currently available display size at a computing device. To illustrate further, a database table (e.g., database table 102D) may include a first column containing a plurality of products in each row, a second column containing a price for each product, and a plurality of other columns with additional information associated with the product. In this example, the database table 102D for example (which is stored at database 110) may include metadata (e.g., priority information for one or more if not all of the columns) that indicates that if the display size at the computing device is too small to accommodate all of the columns of the database table 102D, the responsive table data (which is to be presented at the computing device) should be formatted to at least include the first and second columns. In this way, the responsive table data is formatted for the display size of the display of the computing device requesting the data. The responsive table data provided to the computing device may be provided by the database in response to a database query or a request for the data, in response to a scrolling through one or more rows of the database table being presented at the computing device, in response to a request for more data to be presented at the computing device, and/or provided in response to other operations.

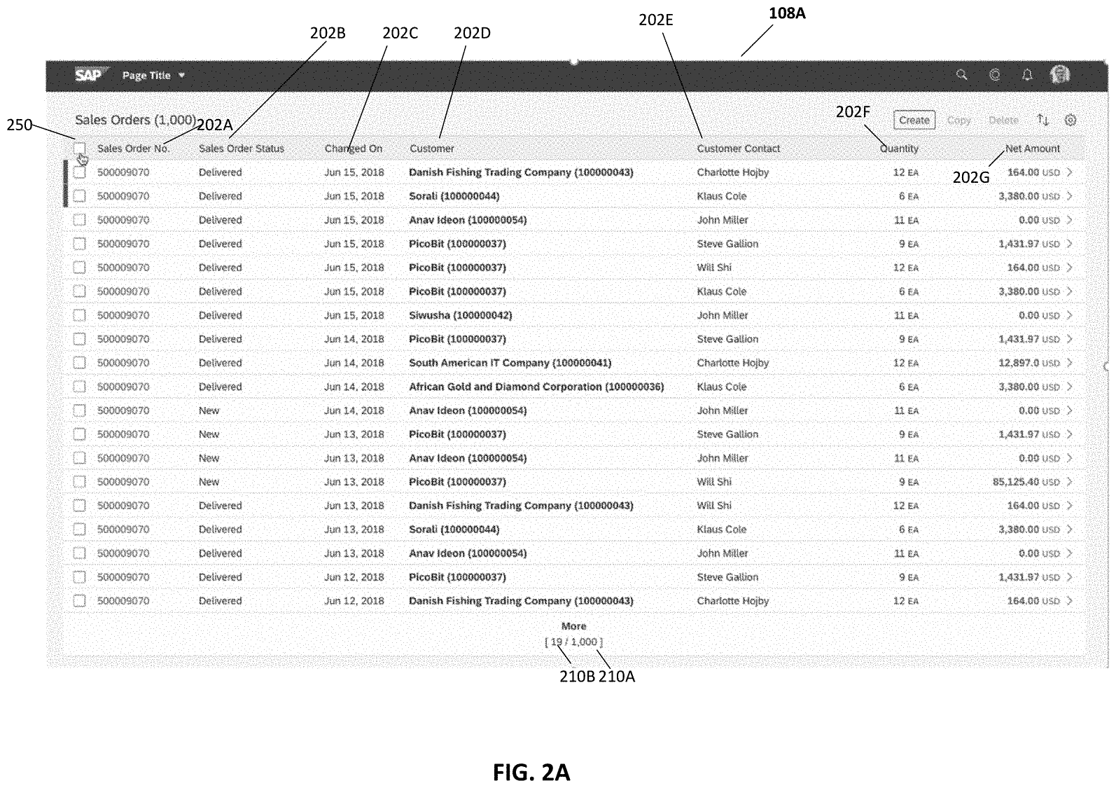

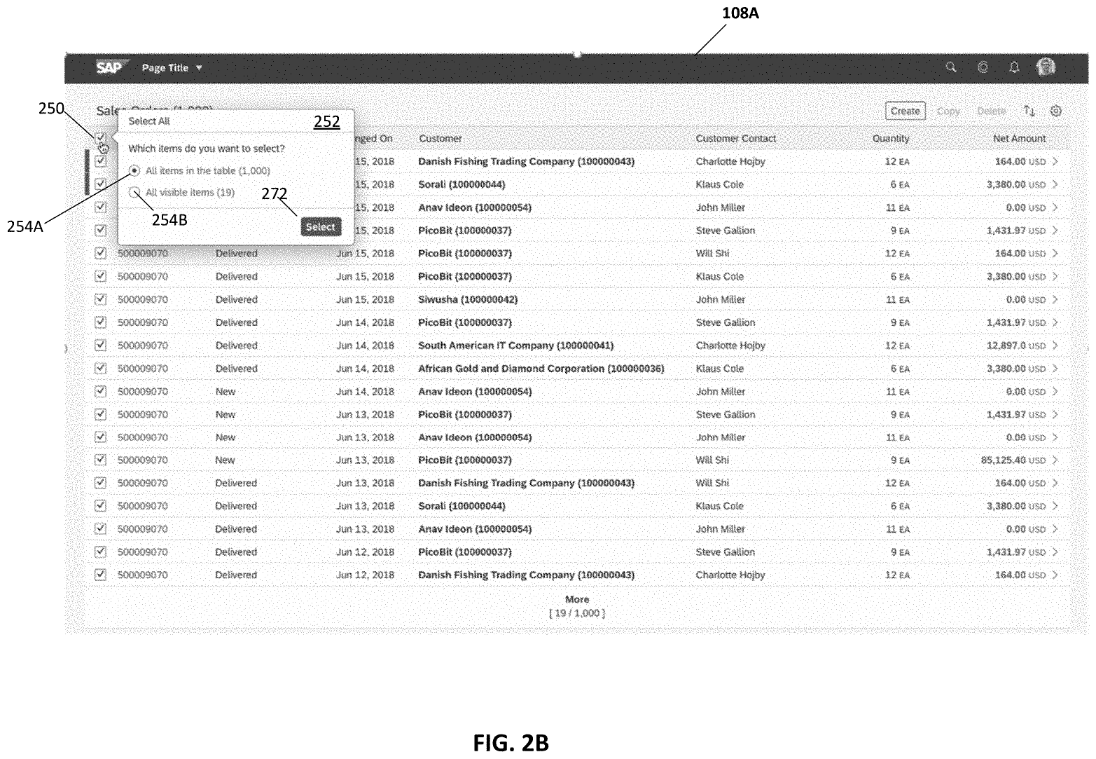

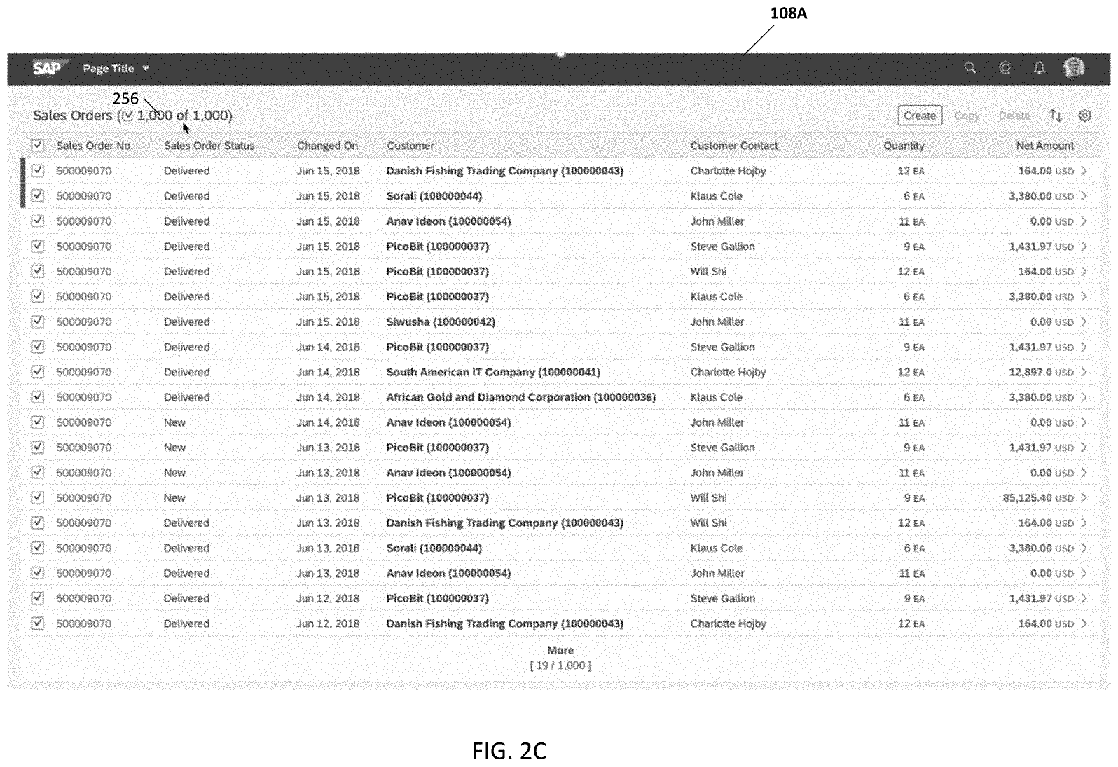

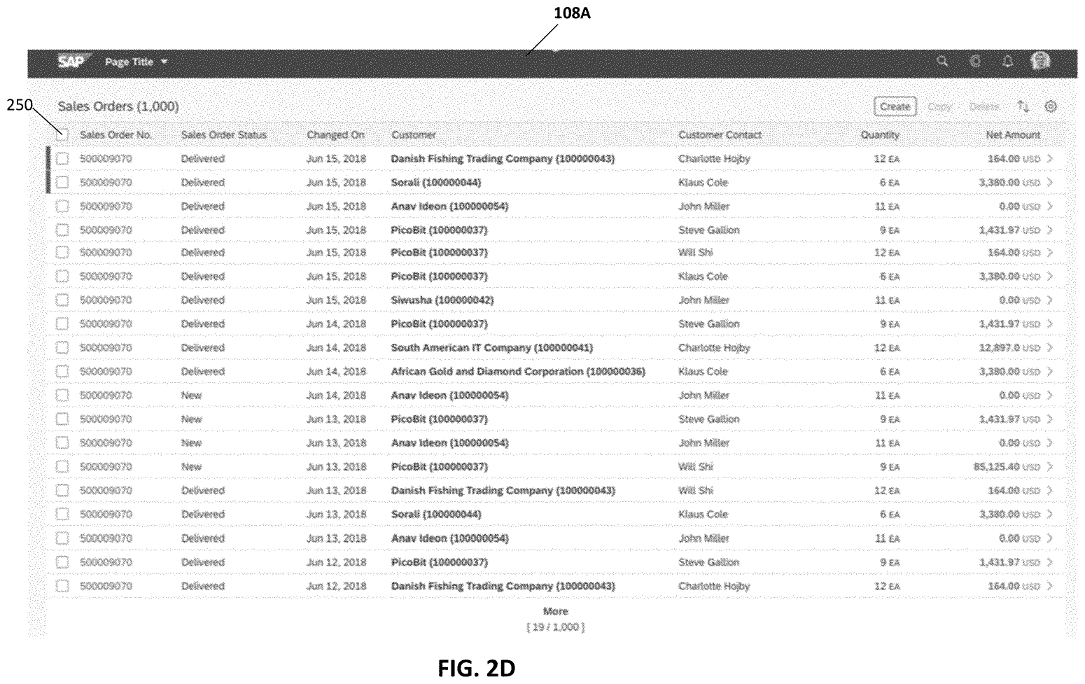

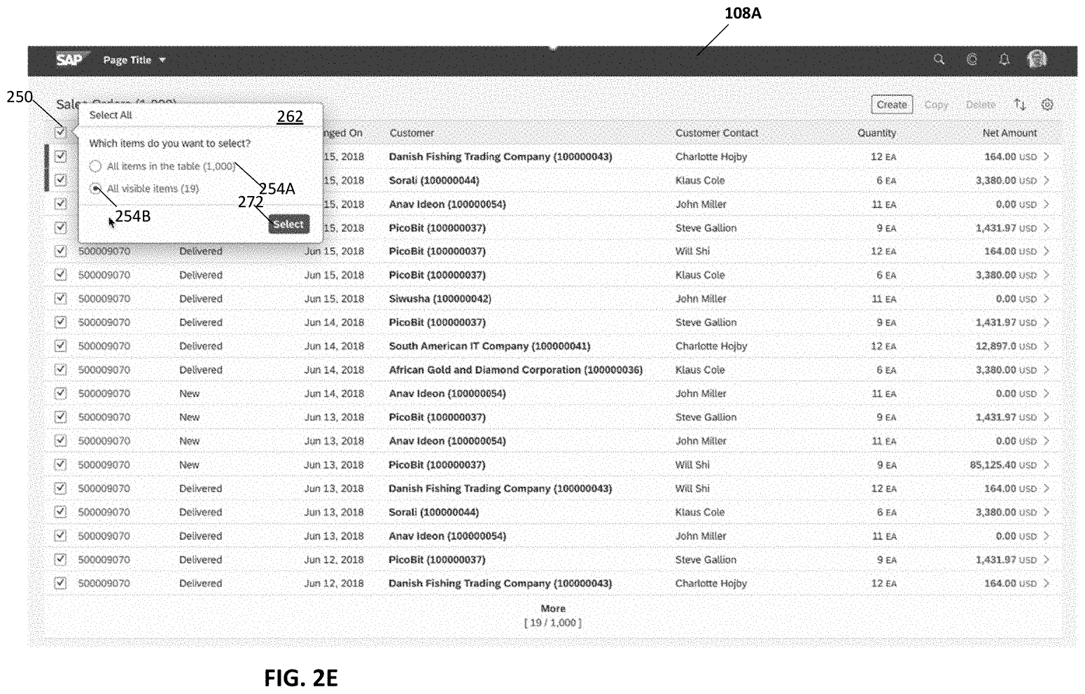

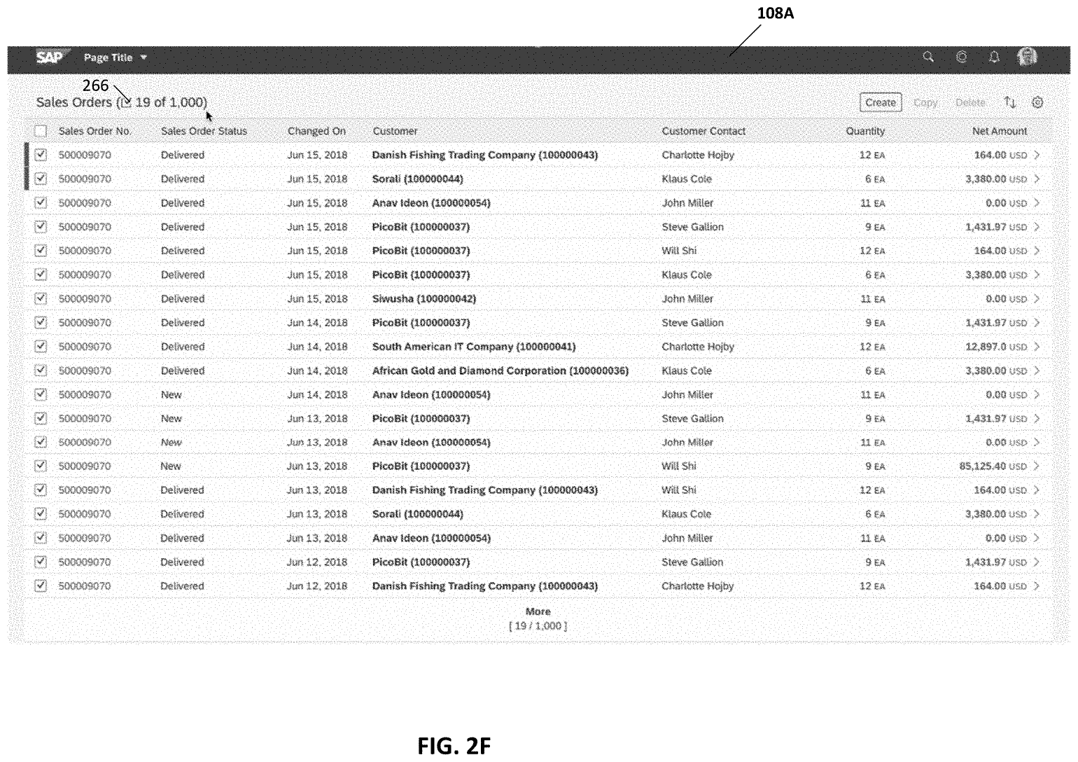

FIG. 2A depicts an example of the user interface 108A, in accordance with some example embodiments. The user interface 108A presents a portion of a database table 102D stored at, for example, the database 110. The database table may include one or more columns and one or more rows. In this example, the one or more columns 202A-G correspond to sales order number 202A, sales order status 202B, and so forth as shown at FIG. 2A (although other types and/or quantities of columns may be implemented as well).

In the example of FIG. 2A, the database table 102D stored at database 110 includes 1000 rows (e.g., data which may be stored as records) as indicated at 210A, but only 19 rows (as indicated by 210B) are being presented by the user interface 108A via the display 106A of the computing device 104A. In this example, the display size corresponds to 19 rows. If an action, such as “select all,” is performed on data of the database table depicted at FIG. 2A, there may be a problem given that there is an ambiguity related to whether the “select all” operation refers to all the data currently being presented (which in the example of FIG. 2A includes 19 items as indicated at 210B) via the user interface 108A or all of the data (which in the example of FIG. 2A includes 1000 items as indicated by 210A) of the database table 102D.

In some example embodiments, the selection of the user interface element 250 (as shown at FIG. 2A) indicates a “select all” selection at the user interface 108A. In response to detection of the selection of the user interface element 250, the computing device 104A causes user interface 252 to be presented as shown at FIG. 2B. The user interface 252 includes a first user interface element 254A and a second user interface element 254B. The selection of the first user interface element 254A indicates that all of the data items in the database table (e.g., table 102D stored at database 110) should be selected by the select all operation. Alternatively, the selection of the second user interface element 254B indicates that only the data items currently being presented via user interface 108A should be selected by the select all operation.

In the example of FIG. 2B, the selection of the first user interface element 254A is performed FIG. 2B also includes a “Select” user interface element 272, which when selected via the user interface 108A executes the chosen select all operation (e.g., providing indication of the selection to a display controller or database, providing metadata regarding current display size, etc.). As noted, the first user interface element 254A indicates that all of the data items of table 102D stored at database 110 should be selected by the select all operation, which in this example corresponds to all 1000 items in the table being selected. In the example of FIG. 2C, the selection of all 1000 items is confirmed as shown at 256 (e.g., checkmark showing 1000 of 1000 selected).

In the example of FIG. 2D, the selection of the user interface element 250 is performed to indicate the “select all” operation. In response to the selection of the user interface element 250, the computing device 104A causes user interface 262 to be presented as shown at FIG. 2E. In the example of FIG. 2E, the second user interface element 254B is selected to indicate that the “select all” operation corresponds to only the items currently being presented at the user interface 108A. FIG. 2E also includes a “Select” user interface element 272, which when selected via the user interface 108A executes the chosen select all operation (e.g., providing indication of the selection to a display controller or database, providing metadata regarding current display size, etc.). In the FIG. 2E example, only 19 items are currently being presented at the user interface 108A. At FIG. 2F, the selection of all 19 items is confirmed as shown at 266 (e.g., checkmark showing 19 of 1000 selected).

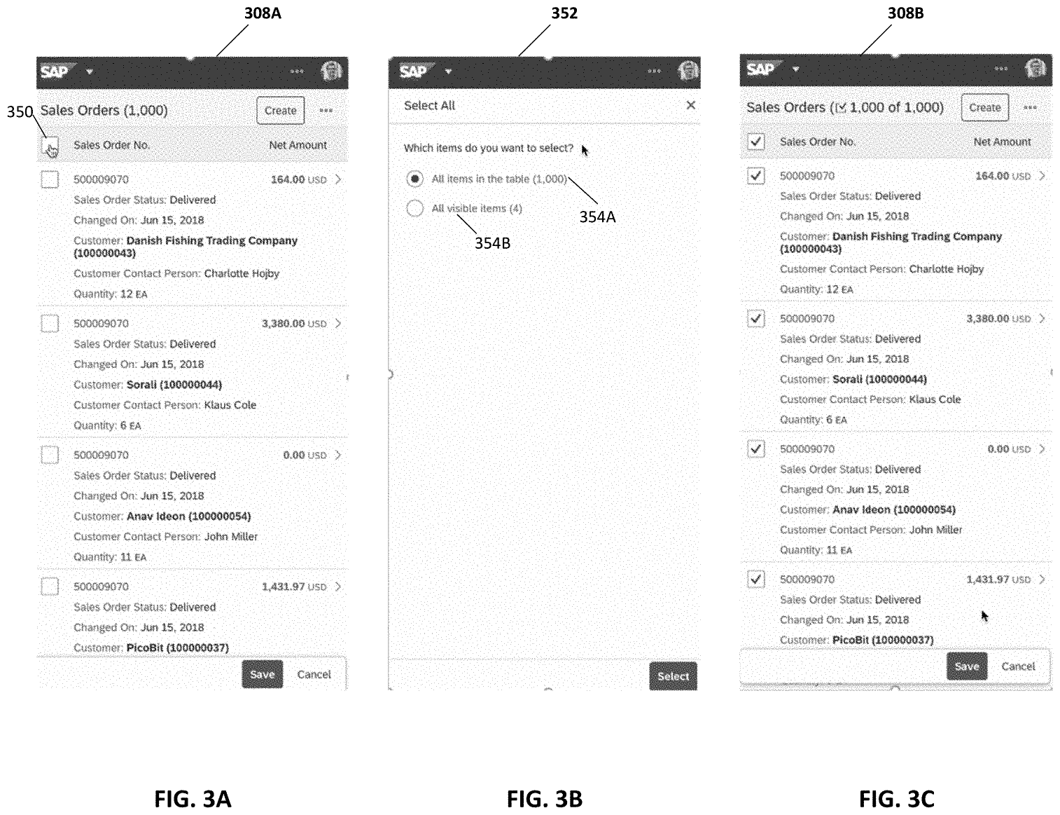

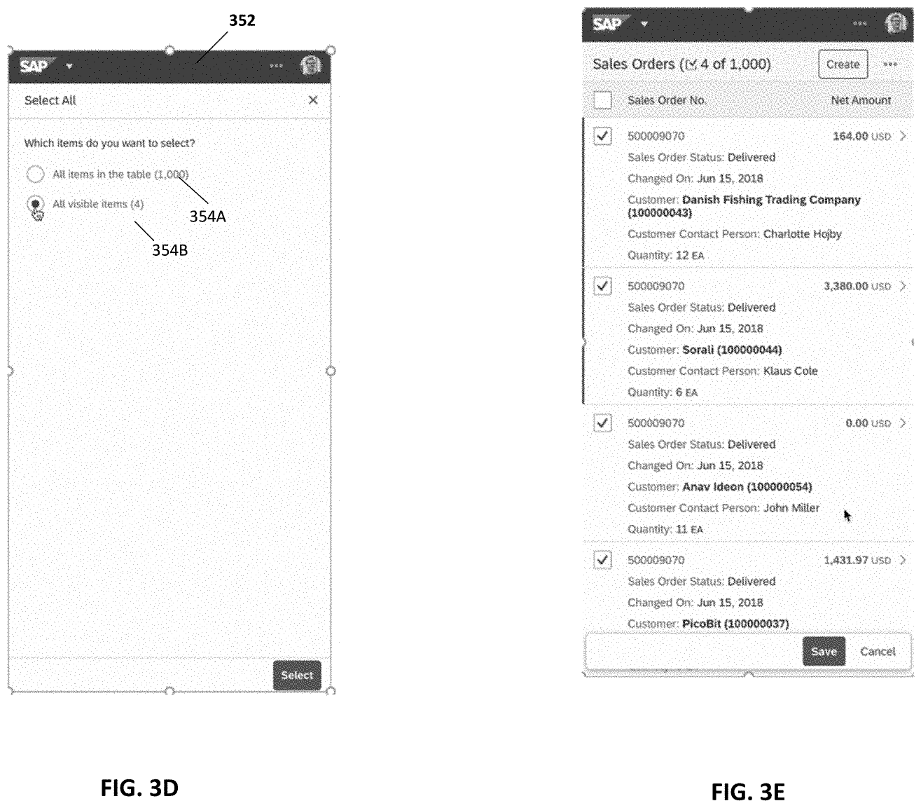

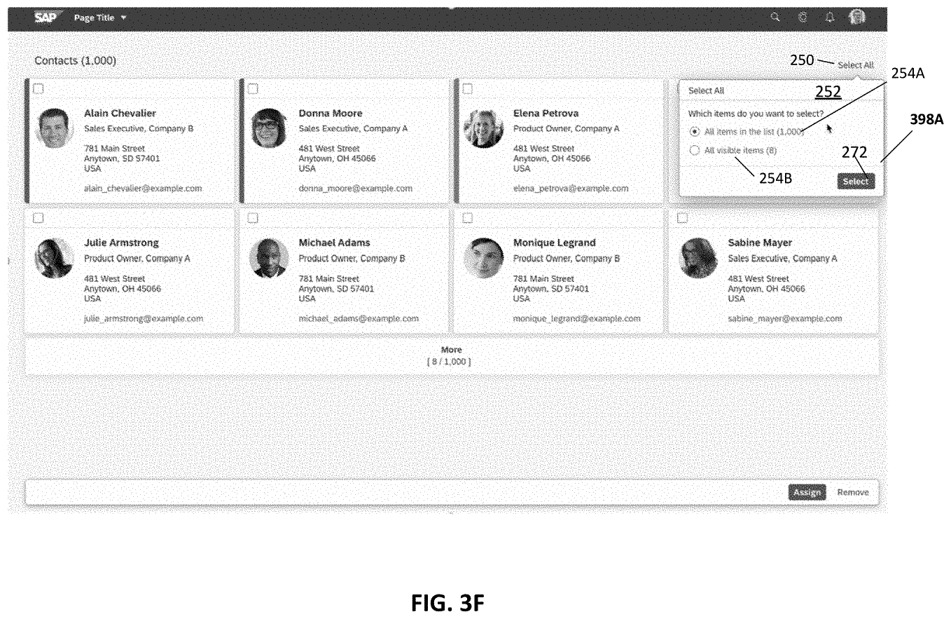

FIG. 3A depicts another example of a user interface 308A, in accordance with some example embodiments. The user interface 308A is similar to 108A in some respects but is formatted in response to a smaller screen size, such as the smaller display size of a tablet computer or smart phone (which may be smaller than a desktop computer such as device 104A).

In response to the selection of the user interface element 350, the computing device 104B (or 104C) for example, causes user interface 352 to be presented as shown at FIG. 3B. The user interface 352 includes a first user interface element 354A and a second user interface element 354B. The selection of the first user interface element 354A indicates that all of the data items in the database table should be selected by the select all operation. FIG. 3C depicts the result set 308B of 1000 data items from the select all chosen at 354A. FIG. 3D depicts user interface 352 but with second user interface element 354B selected, so that only the 4 data items currently being presented via user interface 308A are selected by the select all operation as shown at FIG. 3E.

FIG. 3F depicts another example of a user interface 398A, in accordance with some example embodiments. The user interface 398A is similar to 108A in some respects but is formatted in grid format. In response to the selection of the user interface element 250, the computing device causes user interface 252 to be presented as shown at FIG. 3F. The user interface 252 includes a first user interface element 254A and a second user interface element 254B. The selection of the first user interface element 254A indicates that all of the data items in the database table should be selected by the select all operation, while selection of 254B indicates that only the 8 data items currently being presented via user interface 398 are be selected by the select all operation.

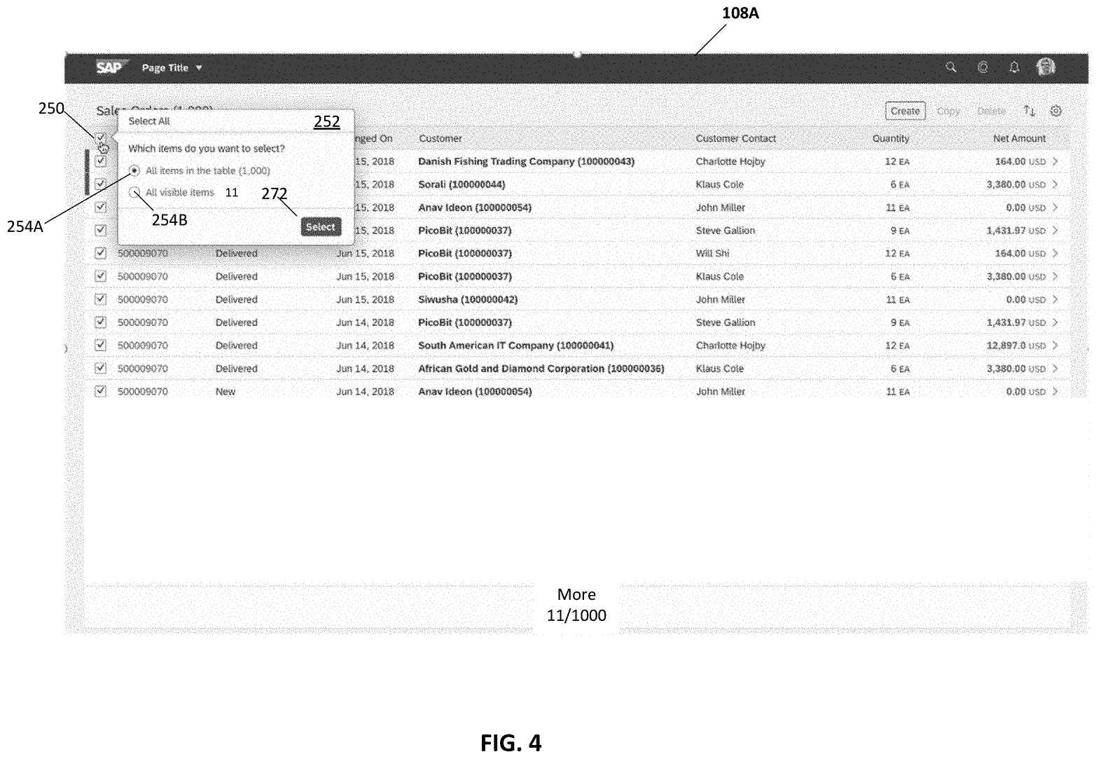

FIG. 4 depicts an example of a user interface 108A including the “select all” user interface element 250. Unlike the example of FIG. 2B above, a filtering operation is performed before the user is provided the option of selecting all items in the table 254A or all visible items 254B. Given 1000 records in the database table and a display size large enough to present only 19 records at a time, a user may initially filter the 1000 entries based on for example, “all purchase orders on June 14 and 16 of 2018.” The result set may only include 11 records as shown at FIG. 4. In this example, the select all visible items 254B would select all 11 items, while the select all items 254A from the table selects all 1000 items in the database table.

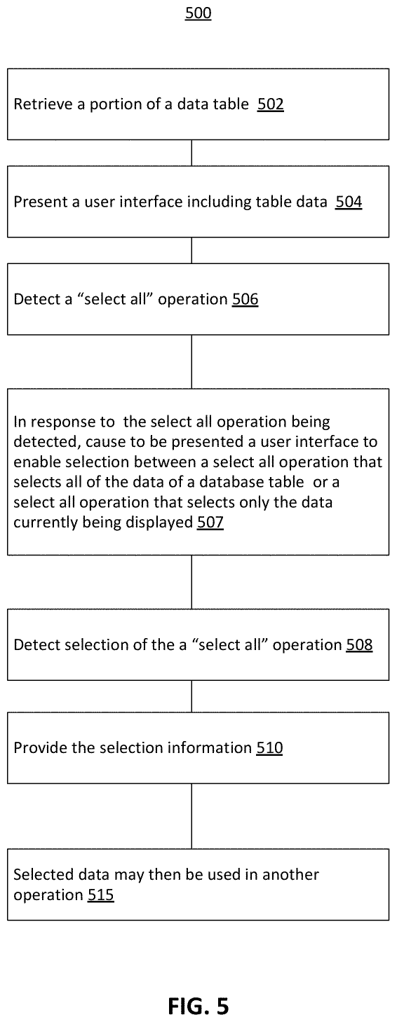

FIG. 5 depicts an example of a process 500, in accordance with some example embodiments.

In some embodiments, the computing device 104A may retrieve, at 502, a portion of a data table from a data store. For example, the data store may be, as noted, stored at database 110 and accessed via network 150, or the data store may be stored locally (e.g., either at the computing device or on a local area network coupled to the computing device 104A). The portion of the data table may be determined based on one or more factors, such as the display size (e.g., the 19 rows of the data table presented at FIG. 2A) and/or a quantity of filtered rows (e.g., the 11 filtered rows noted above with respect to FIG. 4).

At 504, a user interface including table data may be presented at a computing device. For example, the computing device 104A may present at least the portion of table data (or more simply data) retrieved at 502. The data may, as noted, be formatted in response to the display size of the display 106A as shown at FIG. 2A and/or the filtering of FIG. 4.

At 506, an indication of a selection of a “select all” operation is detected. For example, when the selection of user interface 250 is detected, this indicates a select all operation for the data. Although this example depicts a specific type of selection to trigger the “select all,” the select all operation may be invoked in other ways as well.

When the select all operation is detected at 506, a user interface is presented, at 507, to enable selection between a select all operation that selects all of the data of the table 102D (e.g., all 1000 rows of the database table) or a selection of only the data for the rows currently being displayed at the user interface 108A. For example, the select all user interface element 250 is selected as shown at FIG. 2A. In response to this selection, the user interface 252 is presented at the computing device. The user interface includes the first user interface element 254A (which indicates that all of the data items in the database table should be selected by the select all operation) and the second user interface element 254B (which indicates that only the data items currently being presented via user interface 108A should be selected by the select all operation).

At 508, the computing device may detect the selection of the first user interface element 254A (which indicates that all of the data items in the database table stored at database 110 should be selected by the select all operation) or the second user interface element 254B (which indicates that only the data items currently being presented via user interface 108A should be selected by the select all operation).

In response to the first user interface element 254A (which indicates that all of the data items in the database table stored at database 110 should be selected by the select all operation), the user interface 108A may provides, at 510, the selection information to the database 110. This indicates to the database 110 that all of the data items of the database table 102D have been selected. In the example of FIG. 2B, all 1000 rows are selected. In some implementations, the database may provide some (if not all) of the selected rows to the computing device 104A (if those data for the selected rows has not been previously provided to the computing device).

In response to the second user interface element 254B (which indicates that only the data items currently being presented via user interface 108A should be selected by the select all operation), the user interface 108A may provide, at 510, the selection information to the database 110. In some instances, the user interface may also provide the currently presented/displayed rows (e.g., data) as well. In the example of FIGS. 2E-F, 19 rows are selected under the select all.

At 515, the selected data may then be used in another operation. For example, the selected data, such as 19 rows (e.g., in the case of 254B) or 1000 rows (in the case of 254A), may be deleted, copied, moved, and/or processed using other types of operations.

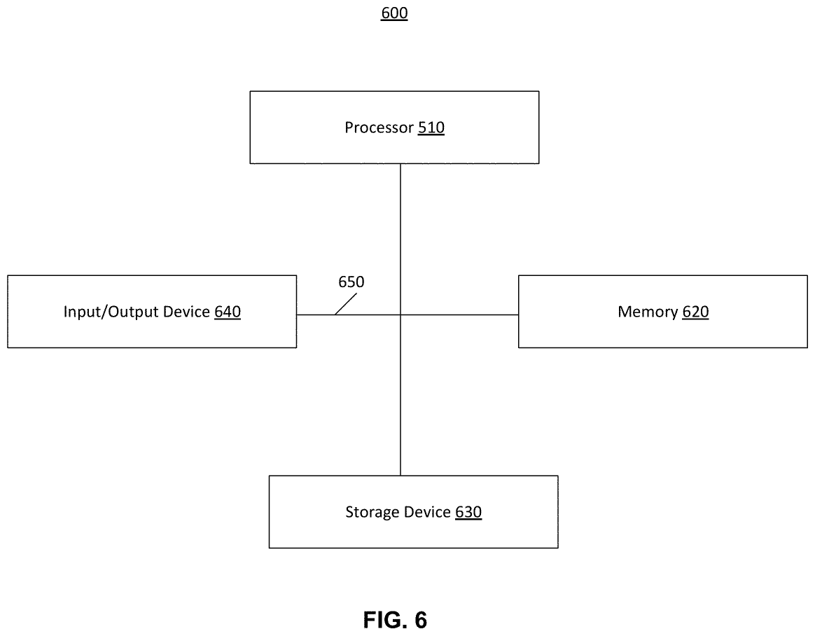

In some implementations, the current subject matter can be configured to be implemented in a system 600, as shown in FIG. 6. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some implementations, the storage device 630 can be a computer-readable medium. In alternate implementations, the storage device 630 can be a floppy disk device, a hard disk device, an optical disk device, a tape device, non-volatile solid-state memory, or any other type of storage device. The input/output device 640 can be configured to provide input/output operations for the system 600. In some implementations, the input/output device 640 can include a keyboard and/or pointing device. In alternate implementations, the input/output device 640 can include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A method comprising:
retrieving a first portion of a data table from a data store, wherein the first portion of the data table is a subset of the data table, and wherein the first portion is determined based on a first factor;
presenting, at a computing device, the first portion at a first user interface, the first user interface further including a select all operation associated with the data table;
detecting, at the computing device, a selection of the select all operation associated with the data table;
in response to the detecting of the selection of the select all operation, presenting a second user interface including a first user interface element and a second user interface element, wherein the first user interface element is configured to indicate all of the data table is included in the select all operation, and wherein the second user interface element is configured to indicate the first portion of the data table is included in the select all operation; and
detecting, at the computer device, a selection of the first user interface element or the second user interface element.

2. The method of claim 1, further comprising:
in response to detecting the selection of the first user interface element, performing an operation on all of the data in the data table.

3. The method of claim 2 further comprising
receiving an indication of the operation, wherein the operation comprises at least one of a copy, a delete, and a move on all of the data table.

4. The method of claim 1, further comprising:
in response to detecting the selection of the second user interface element, performing an operation on the first portion of the data table.

5. The method of claim 4 further comprising
receiving an indication of the operation, wherein the operation comprises at least one of a copy, a delete, and a move on the first portion of the data table.

6. The method of claim 1, wherein the first factor comprises a display size of the computing device.

7. The method of claim 1, wherein the first factor comprises a filtering of the data table.

8. The method of claim 1, wherein the computing device includes the data store.

9. The method of claim 1, wherein the data table comprises a database table, wherein the data store comprises a database coupled to the computing device via a network, and wherein information regarding the selection of the first user interface element or the second user interface element is provided to the database.

10. A system comprising:
at least one processor; and
at least one memory including program code which when executed by the at least one processor causes operations comprising:
retrieving a first portion of a data table from a data store, wherein the first portion of the data table is a subset of the data table, and wherein the first portion is determined based on a first factor;
presenting, at a computing device, the first portion at a first user interface, the first user interface further including a select all operation associated with the data table;
detecting, at the computing device, a selection of the select all operation associated with the data table;
in response to the detecting of the selection of the select all operation, presenting a second user interface including a first user interface element and a second user interface element, wherein the first user interface element is configured to indicate all of the data table is included in the select all operation, and wherein the second user interface element is configured to indicate the first portion of the data table is included in the select all operation; and
detecting a selection of the first user interface element or the second user interface element.

11. The system of claim 10, further comprising:
in response to detecting the selection of the first user interface element, performing an operation on all of the data in the data table.

12. The system of claim 11 further comprising:
receiving an indication of the operation, wherein the operation comprises at least one of a copy, a delete, and a move on all of the data table.

13. The system of claim 10, further comprising:
in response to detecting the selection of the second user interface element, performing an operation on the first portion of the data table.

14. The system of claim 13 further comprising
receiving an indication of the operation, wherein the operation comprises at least one of a copy, a delete, and a move on the first portion of the data table.

15. The system of claim 10, wherein the first factor comprises a display size of a computing device.

16. The system of claim 10, wherein the first factor comprises a filtering of the data table.

17. The system of claim 10, wherein the system includes the data store.

18. The system of claim 10, wherein the data table comprises a database table, wherein the data store comprises a database coupled to the system via a network, and wherein information regarding the selection of the first user interface element or the second user interface element is provided to the database.

19. A non-transitory computer-readable storage medium including program code which when executed by at least one processor causes operations comprising:
retrieving a first portion of a data table from a data store, wherein the first portion of the data table is a subset of the data table, and wherein the first portion is determined based on a first factor;
presenting, at a computing device, the first portion at a first user interface, the first user interface further including a select all operation associated with the data table;
detecting, at the computing device, a selection of the select all operation associated with the data table;
in response to the detecting of the selection of the select all operation, presenting a second user interface including a first user interface element and a second user interface element, wherein the first user interface element is configured to indicate all of the data table is included in the select all operation, and wherein the second user interface element is configured to indicate the first portion of the data table is included in the select all operation; and
detecting a selection of the first user interface element or the second user interface element.

20. The non-transitory computer-readable storage medium of claim 19, further comprising:
in response to detecting the selection of the first user interface element, performing an operation on all of the data in the data table; and
in response to detecting the selection of the second user interface element, performing an operation on the first portion of the data table.
